(19) United States
(12) Patent Application Publication
(10) Pub. No.: US 2011/0106302 A1
(43) Pub. Date: May 5, 2011

(54) ROBOT ARM ASSEMBLY AND INDUSTRIAL ROBOT USING THE SAME

(75) Inventor: BO LONG, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/703,125

(22) Filed: Feb. 9, 2010

(30) Foreign Application Priority Data
Oct. 30, 2009 (CN) 200910309085.0

(51) Int. Cl. G06F 19/00; B25J 18/06; B25J 17/00

(52) U.S. Cl. 700/245; 74/490.03; 74/490.05

(57) ABSTRACT

A robot arm assembly includes a first joint unit, a first motor, a first gear transmission, a second joint unit, a second motor, a second gear transmission, a third joint unit and a control unit. The first joint unit, the second joint unit and the third joint unit are rotatably connected in order, and rotatable around a first, second, and third axes respectively. The first gear transmission is coupled to the first motor to drive the first joint unit. The second gear transmission is coupled to the second motor to drive the second joint unit. The control unit controls the first and second motors. The first joint unit, the second joint unit and third joint unit intersect at a point. An angle between the second axis and the third axis is between zero and 90°.

### CROSS-REFERENCE TO RELATED APPLICATIONS

This application is related to a co-pending U.S. patent application, application Ser. No. ______, with Attorney Docket No. US29599, and entitled “ROBOT ARM ASSEMBLY AND INDUSTRIAL ROBOT USING THE SAM”. The inventor of the co-pending application is Bo Long. The co-pending application has the same assignee as the present application.

### BACKGROUND

1. Technical Field

The present disclosure generally relates to robot arm assemblies, and particularly to a robot assembly for an industrial robot comprising of a plurality of joints.

2. Description of the Related Art

A commonly used industrial robot includes a fixed base, a frame rotatably connected thereto about a first axis, a lower arm, one end of which is rotatably connected to the frame about a second axis, and an upper arm, one end of which is rotatably connected to the other end of the lower arm about a third axis. An end effector, such as a welding device, a gripper, or a cutting tool, is mounted at a distal end of the upper arm of the industrial robot to execute specific tasks. Generally, a total of six axes are utilized to achieve maximum movement of the end effectors.

In typical robots of this kind, each arm of the robot is rotated by a driving unit relative to a rotation axis. Typically, the driving unit includes a motor mounted on a first arm and a speed reducer coupled to the motor to transmit the movement of the motor to a second arm. The speed reducer may be a gear with a high gear ratio, such as a harmonic gear reducer, a rotary vector reducer (RV reducer), or a planetary reducer. The motor and the speed reducer are arranged along the rotation axis of the first or second arm, expanding the range to be relatively large. In a six-axis industrial robot, the fifth axis is rotatably connected to the sixth axis and may be perpendicular. The fifth and sixth axes are respectively driven by two driving units arranged adjacent to each other, such that the total size of the fifth and sixth axes is relatively large. As a result, the industrial robots need considerable amount of space to operate freely and safely.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is a plan view of one embodiment of an industrial robot, having a robot assembly and six rotating axes.

FIG. 2 is an isometric view of a robot arm assembly deployed on an industrial robot such as, for example, that of FIG. 1.

FIG. 3 is a cross section of the robot arm assembly of FIG. 2, taken along line III-III thereof.

### DETAILED DESCRIPTION

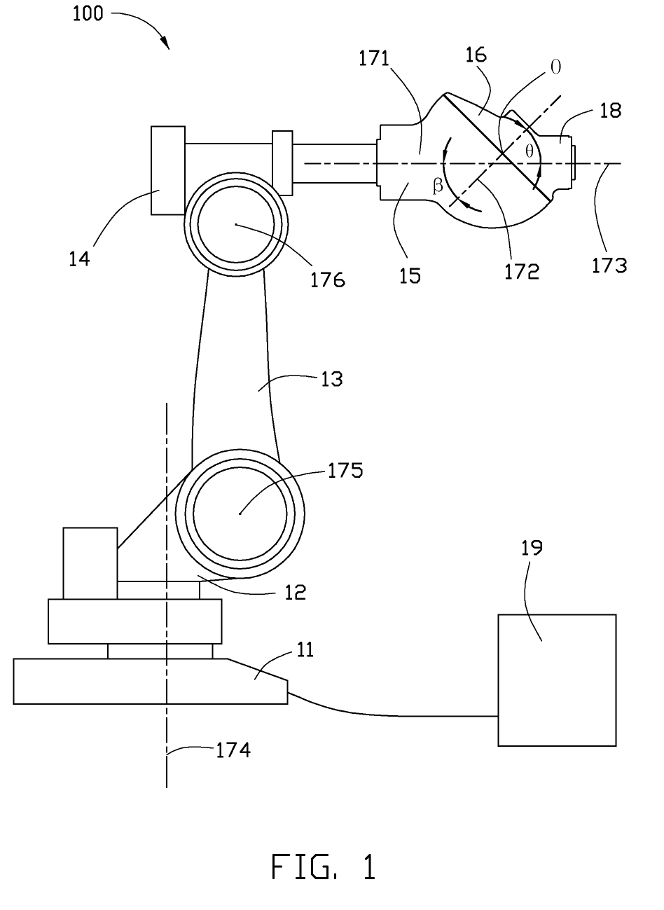

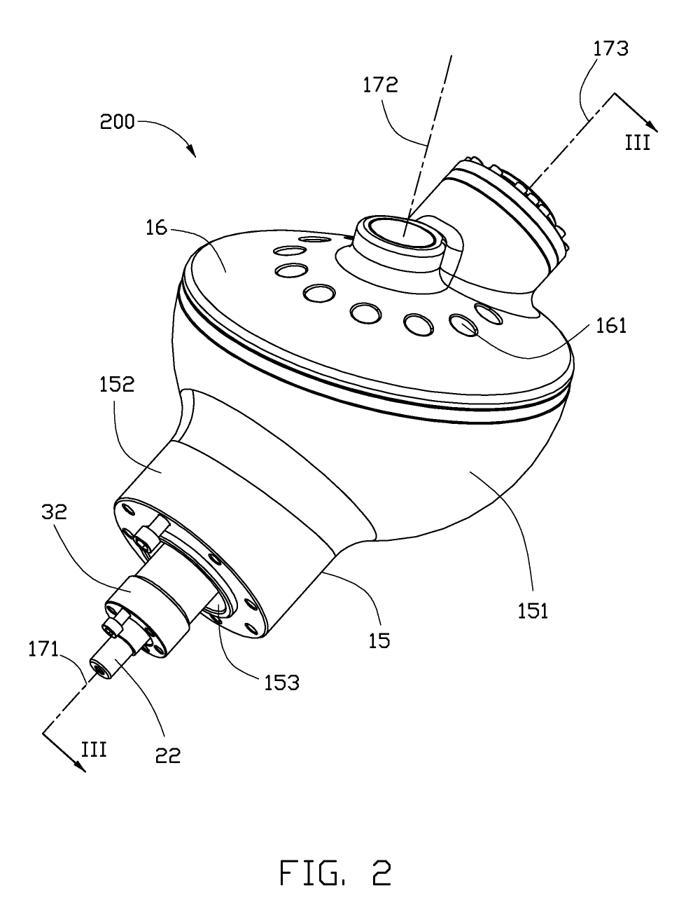

Referring to FIGS. 1 and 2, one embodiment of an industrial robot 100 may be a six-axis industrial robot. The industrial robot 100 includes a base seat 11, a bracket 12, a first arm 13, a second arm 14, a robot arm assembly 200 and a control unit 19. The robot arm assembly 200 includes a first joint unit 15, a second joint unit 16, and a third joint unit 18. The base seat 11, the bracket 12, the first arm 13, the second arm 14, the first joint unit 15, the second joint unit 16 and the third joint unit 18 are rotatably connected in order. The control unit 19 governs the operation of the industrial robot 100. An end effector (not shown) is generally positioned on a distal end of the third joint unit 18 to perform or accomplish various operations, such as clamping, cutting and so on.

The industrial robot 100 has six rotating axes. The first joint unit 15, the second joint unit 16, the third joint unit 18, the bracket 12, the first arm 13 and the second arm 14 are rotatable around a first, second, third, fourth, fifth and sixth axes 171, 172, 173, 174, 175 and 176, respectively. The first joint unit 15, the second joint unit 16 and the third joint unit 18 intersect at a point O. An angle θ defined by the second axis 172 and the third axis 173 is between zero and 90°. An angle β defined by the second axis 172 and the first axis 171 is between zero and 90°. In the illustrated embodiment, both the angle θ and the angle β are 45°.

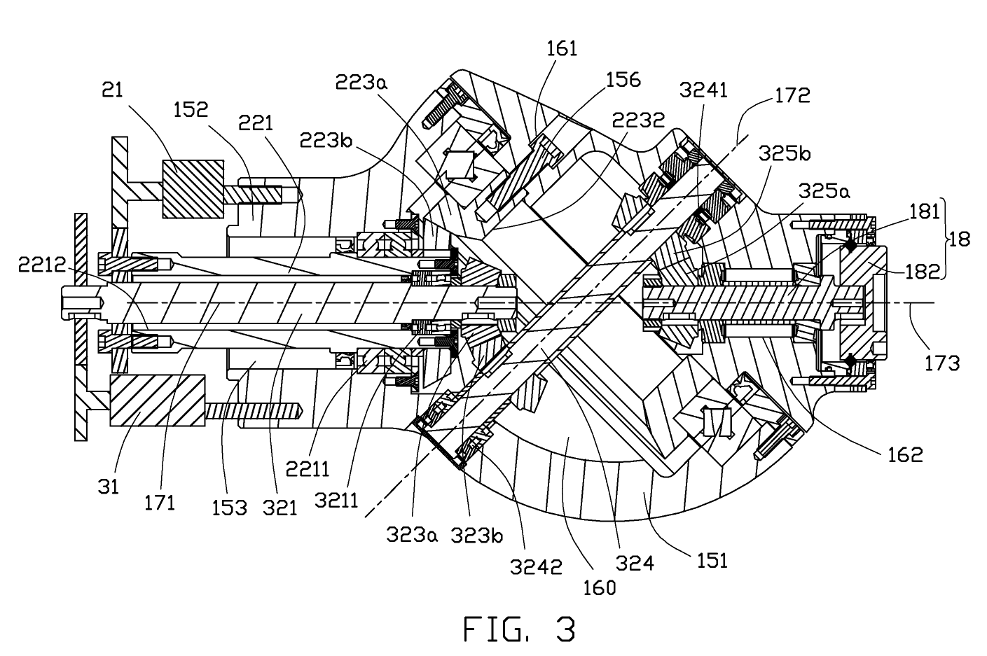

Referring to FIGS. 2 and 3, the robot arm assembly 200 further includes a first motor 21, a first gear transmission 22, a second motor 31 and a second gear transmission 32. The first motor 21 and the second motor 31 are fixed to the first joint unit 15. The first motor 21 drives the second joint unit 16 via the first gear transmission 22. The second motor 31 drives the third joint unit 18 via the second gear transmission 32.

The first joint unit 15 includes a first connecting portion 151 and a second connecting portion 152 integrally formed with the first connecting portion 151. The first connecting portion 151 is substantially hemispherical. The second joint unit 16 is rotatably connected to the first connecting portion 151. The second connecting portion 152 is substantially cylindrical, and extends along the first axis 171. The second connecting portion 152 defines a hollow channel 153 extending along the first axis 171.

The second joint unit 16 is substantially a circular cover body. The second joint unit 16 defines a plurality of connecting holes 161 arranged around the second axis 172, and a mounting hole 162 along the third axis 173 on a middle portion of the second joint unit 16. The third joint unit 18 is received in the mounting hole 162. The second joint unit 16 and the first joint unit 15 cooperatively define a receiving portion 160 for receiving the first gear transmission 22 and the second gear transmission 32.

The first gear transmission 22 includes a first transmission shaft 221 and a pair of first bevel gears 223a, 223b. The first motor 21 and the pair of first bevel gears 223a, 223b are fixed at the ends of the first transmission shaft 221 and the second joint unit 16. The first transmission shaft 221 is received in the hollow channel 153. The first transmission shaft 221 defines a through hole 2212 extending along an axis of the first transmission shaft 221. The bevel gear 223a is fixed to the second joint unit 16 via a plurality of threading members 156 interconnecting the bevel gear 223a and the second joint unit 16. The first bevel gear 223a defines a central hole 2232. The first bevel gear 223b is fixed to the first transmission shaft 221 by interference fit.

The second gear transmission 32 includes a second transmission shaft 321, a pair of second bevel gears 323a, 323b, a central shaft 324 and a pair of third bevel gears 325a, 325b. The second transmission shaft 321 includes a bearing 3211 rotatably sleeved on an end thereof. The second transmission shaft 321 is received in the through hole 2212 of the first transmission shaft 221, and is rotatable around the first axis 171. The central shaft 324 is received in the central hole 2232 of the first bevel gear 223a, and rotatable around the axis 172. The second gear transmission 32 further includes a pair of bearing 3241, 3242 rotatably sleeved on opposite ends of the central shaft 324. The pair of the bearings 3241, 3242 is fixed to the second joint unit 16. The second bevel gear 323b and the third bevel gear 325b are fixed on opposite ends of the central shaft 324. The second bevel gear 323b and the third bevel gear 325a are respectively fixed on an end of the second transmission shaft 324 and the third joint unit 18.

The third joint unit 18 includes a third transmission shaft 181 and a rotatable member 182 fixed on an end of the third transmission shaft 181. The third bevel gear 325a and the rotatable member 182 are respectively fixed to opposite ends of the third transmission shaft 181. The rotatable member 182 is fixed to the end effector.

The robot arm assembly 200 is operated as follows.

The control unit 19 is programmable with control instructions therein. The first gear transmission 22 transmits the movement of the first motor 21 to the second joint unit 16 to rotate the second axis 172 around the rotation axis thereof, in response to the control instructions for the first motor 21. Simultaneously, the third joint unit 18 can follow the rotation of the second joint unit 16 to rotate around the second axis 171, and rotate around the third axis 173, as the pair of second bevel gears 323a, 323b and the pair of third bevel gears 325a, 325b engage, such that an error is produced (defining the error as a following rotation error here). To compensate for the error, the third joint unit 18 rotates synchronously around the third axis 173 driven by the second gear transmission 32, in response to the control instruction for the second motor 31. Therefore, the third joint unit 18 can be kept in the current position while the second joint unit 16 is rotating. When independent control of the third joint unit 18 is required, the second motor 31 drives the third transmission shaft 181 via the second gear transmission 32 to a predetermined angle around the third axis 173, in response to control instructions from the control unit 19. The rotation of the second joint unit 18 does not change the position of the second joint unit 16, such that the third joint unit 18 can be positioned accurately by using the control unit 19 as described.

The first and second motors 21, 31 can be mounted at an end of the first arm 15 away from the second joint unit 16 and the third joint unit 18, such that it is not necessary to arrange the first and second motors 21, 31 along the second and third axes 172, 173, respectively. Therefore, the extension along both the second and third axes 172, 173 is minimized, and the robot arm assembly 200 thus is more compact.

In addition, loads on the second axis 172 applied by the second motor 31 and the speed reducer weight can be removed to facilitate control of the second axis and third axes 172, 173. Since the first and second gear transmissions 22, 32 each applies a single-stage transmission, a predetermined gear ratio can be achieved, and the first and second gear transmissions 22, 32 can use standard gears, so that costs are conserved. Furthermore, the space occupied by the robot arm assembly 200 is further conserved due to the hollow structure of the first joint unit 16, thereby allowing at least a partial reception of the first and second gear transmissions 22, 32 therein. The second axis 172 obliquely crosses the third axis 173, thereby the third joint unit 18 does not collide with the first joint unit 15, such that the second joint unit 16 is rotatable around the second axis 172 in a complete circle.

It should be understood that one or more gear transmission stages can also be added to or removed from the first and second gear transmissions 22, 32 to achieve a predetermined gear ratio. The second transmission shaft 321 can be tubular, with the first transmission shaft 221 received in the second transmission shaft 321.

It should also be understood that the industrial robot 100 is not limited to a six-axis industrial robot, and can alternatively deploy fewer axes with the disclosed three axes well within the scope of the disclosure.

Finally, while the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure as defined by the appended claims.

What is claimed is:

1. A robot arm assembly, comprising:
a first joint unit capable of rotating around a first axis;
a first motor;
a first gear transmission coupled to the first motor to drive the first joint unit;
a second joint unit rotatably connected to the first joint unit and capable of rotating around a second axis;
a second motor;
a second gear transmission coupled to the second motor to drive the second joint unit;
a third joint unit rotatably connected to the second joint unit and capable of rotating around a third axis, wherein the first joint unit, the second joint unit and third joint unit intersect at a point;
a control unit controlling the first and second motors, wherein an angle between the second axis and the third axis is between zero and 90°; the first gear transmission comprises a first transmission shaft and a pair of first bevel gears respectively fixed on an end of the first transmission shaft and the second joint unit, the second gear transmission comprises a central shaft rotatably connected to the second joint unit, a pair of second bevel gears meshing with each other and a pair of third bevel gears meshing with each other, one second bevel gear and one third bevel gear fixed on opposite ends of the central shaft and the other second bevel gear and third bevel gear respectively fixed on an end of the second transmission shaft and the third joint unit.

2. The robot arm assembly of claim 1, wherein the first joint unit comprises a first connecting portion and a second connecting portion integrally formed with the first connecting portion, wherein the second joint unit is rotatably connected to the first connecting portion.

3. The robot arm assembly of claim 2, wherein the second connecting portion defines a hollow channel receiving the first transmission shaft extending along the first axis.

4. The robot arm assembly of claim 1, wherein the second joint unit defines a mounting hole along the third axis on a middle portion of the second joint unit for receiving the third joint unit.

5. The robot arm assembly of claim 1, wherein the second joint unit and the first joint unit cooperatively define a receiving portion receiving the first gear transmission and the second gear transmission.

6. The robot arm assembly of claim 1, wherein the first transmission shaft defines a through hole receiving the second transmission shaft extending along the axis of the first transmission shaft.

7. The robot arm assembly of claim 6, wherein the second gear transmission further comprises a pair of bearings rotatably sleeved on opposite ends of the central shaft.

8. The robot arm assembly of claim 1, the third joint unit comprises a third transmission shaft and a rotatable member fixed on an end of the third transmission shaft.

9. The robot arm assembly of claim 8, wherein an angle between the second axis and the first axis is between zero and 90°.

10. An industrial robot, comprising:
a base seat;
a bracket rotatably connected to the base seat;
a first arm rotatably connected to the bracket;
a second arm rotatably connected to the first arm;
a first joint unit rotatably connecting to the second arm and capable of rotating around a first axis;
a first motor;
a first gear transmission coupled to the first motor to drive the first joint unit;
a second joint unit rotatably connected to the first joint unit and capable of rotating around a second axis;
a second motor;
a second gear transmission coupled to the second motor to drive the second joint unit;
a third joint unit rotatably connected to the second joint unit and rotating around a third axis, wherein the first joint unit, the second joint unit and third joint unit intersect at a point;
a control unit to control the first and second motors;
wherein an angle between the second axis and the third axis is between zero and 90°; the first gear transmission comprises a first transmission shaft and a pair of first bevel gears respectively fixed on an end of the first transmission shaft and the second joint unit, the second gear transmission comprises a central shaft rotatably connected to the second joint unit, a pair of second bevel gears meshing with each other and a pair of third bevel gears meshing with each other, one second bevel gear and one third bevel gear are fixed on opposite ends of the central shaft, and the other second bevel gear and third bevel gear respectively fixed on an end of the second transmission shaft and the third joint unit.

11. The industrial robot of claim 10, wherein the first joint unit comprises a first connecting portion and a second connecting portion integrally formed with the first connecting portion, wherein the second joint unit is rotatably connected to the first connecting portion.

12. The industrial robot of claim 11, wherein the second connecting portion defines a hollow portion receiving the first transmission shaft extending along the first axis.

13. The industrial robot of claim 10, wherein the second joint unit defines a mounting hole along the third axis on a middle portion of the second joint unit for receiving the third joint unit.

14. The industrial robot of claim 10, wherein the second joint unit and the first joint unit cooperatively define a receiving portion receiving the first gear transmission and the second gear transmission.

15. The industrial robot of claim 10, wherein the first transmission shaft defines a through hole receiving the second transmission shaft extending along the axis of the first transmission shaft.

16. The industrial robot of claim 15, wherein the second gear transmission further comprises a pair of bearings rotatably sleeved on opposite ends of the central shaft.

17. The industrial robot of claim 10, the third joint unit comprises a third transmission shaft and a rotatable member fixedly sleeved on an end of the third transmission shaft.

18. The industrial robot of claim 17, wherein an angle between the second axis and the first axis is between zero and 90°.
